(19) United States
(12) Patent Application Publication
(10) Pub. No.: US 2010/0247129 A1
(43) Pub. Date: Sep. 30, 2010

(54) IMAGE FORMING APPARATUS

(76) Inventors: Nobuo Hyakutake, Kanagawa (JP); Taku Fukuhara, Kanagawa (JP); Takashi Kawabata, Kanagawa (JP); Kazutoshi Sugitani, Kanagawa (JP); Kiyotoshi Kaneyama, Kanagawa (JP)

Correspondence Address: MORGAN LEWIS & BOCKIUS LLP, 1111 PENNSYLVANIA AVENUE NW, WASHINGTON, DC, 20004, US

(21) Appl. No.: 12/552,406

(22) Filed: Sep. 2, 2009

(30) Foreign Application Priority Data
Mar. 27, 2009 (JP) 2009-078300

(51) Int. Cl. G03G 15/16; G03G 15/01

(52) U.S. Cl. 399/66; 399/298; 399/299

(57) ABSTRACT

An image forming apparatus includes: an image forming section that forms a plurality of images including an image of a low-gloss toner lower in glossiness than any other color toner and an image of a transparent toner; an intermediate transferer to which the plurality of images formed by the image forming section are transferred; and a control section that controls a position for forming the image of the transparent toner, so as to prevent the image of the transparent toner from being transferred under the image of the low-gloss toner on the intermediate transferer.

### CROSS-REFERENCE TO RELATED APPLICATION

This application is based on and claims priority under 35 USC 119 from Japanese Patent Application No. 2009-078300 filed on Mar. 27, 2009.

### BACKGROUND

1. Technical Field

The present invention relates to an image forming apparatus.

2. Related Art

As the image forming apparatus, an apparatus which has not only a plurality of image forming sections that form images of yellow, magenta, cyan, black, etc. by way of example but also an image forming section that forms an image using a transparent toner to improve the transfer properties of a color image onto embossed paper or the like having irregularities on its surface has been known in the background art.

### SUMMARY

According to an aspect of the invention, there is provided an image forming apparatus including: an image forming section that forms a plurality of images including an image of a low-gloss toner lower in glossiness than any other color toner for forming color image and an image of a transparent toner; an intermediate transferer to which the plurality of images formed by the image forming section are transferred; and a control section that controls a position for forming the image of the transparent toner, so as to prevent the image of the transparent toner from being transferred under the image of the low-gloss toner on the intermediate transferee.

### BRIEF DESCRIPTION OF THE DRAWINGS

Exemplary embodiments of the present invention will be described in detail based on the following figures, wherein:

FIG. 1 is a configuration diagram showing a main portion of a tandem type digital color printer as an image forming apparatus according to a first exemplary embodiment of the invention;

FIG. 2 is a configuration diagram showing the tandem type digital color printer as the image forming apparatus according to the first exemplary embodiment of the invention;

FIG. 3 is a configuration diagram showing a main portion of the tandem type digital color printer as the image forming apparatus according to the first exemplary embodiment of the invention;

FIG. 4 is a graph showing glossiness of toners used in the tandem type digital color printer as the image forming apparatus according to the first exemplary embodiment of the invention;

FIGS. 5A and 5B are tables showing colors of images to be formed and contact/separate states of retract rolls;

FIG. 6 is a schematic view showing toner images transferred onto an intermediate transfer belt;

FIG. 7 is a schematic view showing the toner images formed sequentially on the intermediate transfer belt;

FIG. 8 is a schematic view showing the toner images to be transferred onto a recording sheet of paper;

FIG. 9 is a configuration diagram showing a main portion of a tandem type digital color printer as an image forming apparatus according to a second exemplary embodiment of the invention;

FIG. 10 is a schematic view showing toner images formed on an intermediate transfer belt; and

FIG. 11 is a schematic view showing the toner images formed sequentially on the intermediate transfer belt.

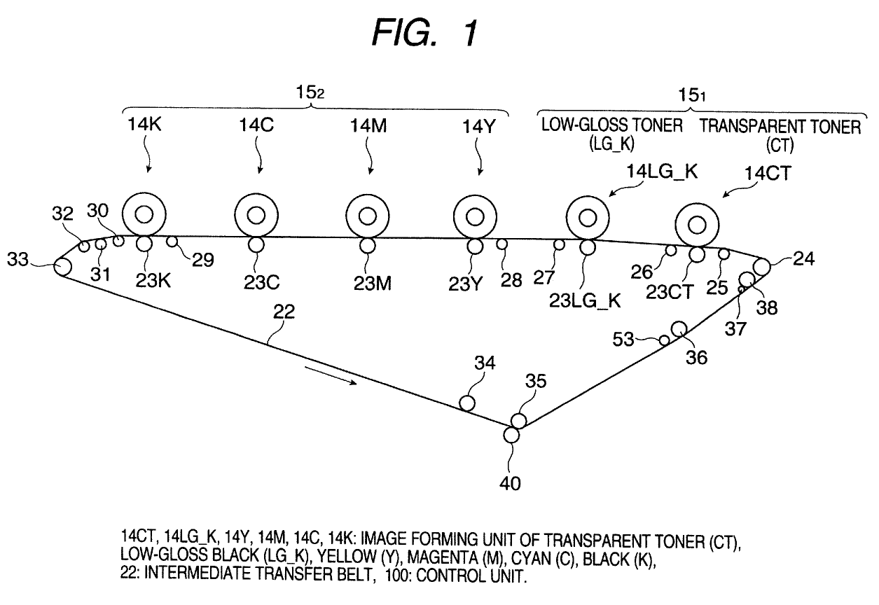

### DESCRIPTION OF REFERENCE NUMERALS AND SIGNS

14CT, 14LG_K, 14Y, 14M, 14C, 14K: image forming unit of transparent toner (CT), low-gloss black (LG_K), yellow (Y), magenta (M), cyan (C), black (K), 22: intermediate transfer belt, and 100: control unit.

### DETAILED DESCRIPTION

Exemplary embodiments of the invention will be described below with reference to the drawings.

### First Exemplary Embodiment

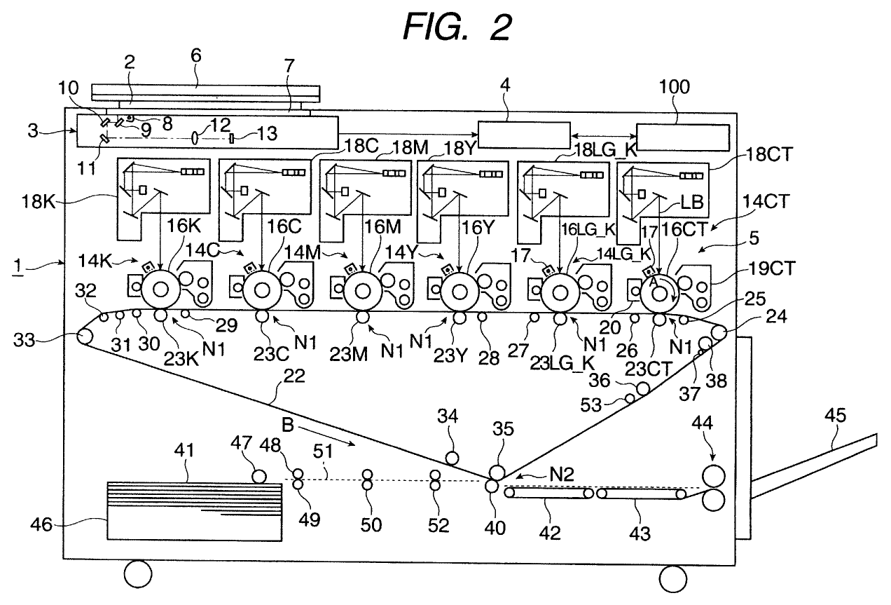

FIG. 2 is a schematic configuration diagram showing a tandem type digital color printer as an image forming apparatus according to a first exemplary embodiment of the invention. The tandem type digital color printer has an image reading unit and also serves as a full color copying machine or a facsimile machine. Not to say, the image forming apparatus does not have to have the image reading unit, but may form an image based on image data output from a not-shown personal computer or the like.

In FIG. 2, the reference numeral 1 represents a tandem type digital color printer body. The digital color printer body 1 has an image reading unit 3 in an upper portion of its one side (left in the illustrated example). The image reading unit 3 reads an image of a document 2. An image processing unit 4 and an image output unit 5 are disposed inside the color printer body 1. The image processing unit 4 performs predetermined image processing upon image data output from the image reading unit 3, a not-shown personal computer or the like, or image data transmitted through a telephone line, a LAN, or the like. The image output unit 5 outputs an image based on the image data on which the predetermined image processing has been performed in the image processing unit 4. The image forming operation including an image forming position in the image output unit 5 is controlled by a control circuit 100 serving as a control section.

The image reading unit 3 is configured as follows. A platen cover 6 is opened and closed to mount the document 2 on a platen glass 7. The document 2 mounted on the platen glass 7 is lit by a light source 8, while an image of reflected light from the document 2 is scanned and exposed on an image reading element 13 through a reduction scanning optical system constituted by a full-rate mirror 9, half mirrors 10 and 11 and an imaging lens 12. The image reading element 13 is constituted by a CCD or the like. The image of the document 2 is read with a predetermined dot density by the image reading element 13.

The image of the document 2 read by the image reading unit 3 is sent to the image processing unit 4 as document reflectance data of three colors such as red (R), green (G) and blue (B) (e.g. 8 bit for each color). In the image processing unit 4, predetermined image processing such as shading correction, position error correction, brightness/color-space conversion, gamma correction, frame elimination, color/movement editing, etc. is performed on the reflectance data of the document 2.

The image data on which the predetermined image processing has been performed in the image processing unit 4 are converted into image data of four colors, yellow (Y), magenta (M), cyan (C) and black (K), and converted into image data of six colors by adding image data of low-gloss black (LG_K) and transparent toner (CT) thereto, by the same image processing unit 4. The image data of six colors are output to the image output unit 5 which will be described next.

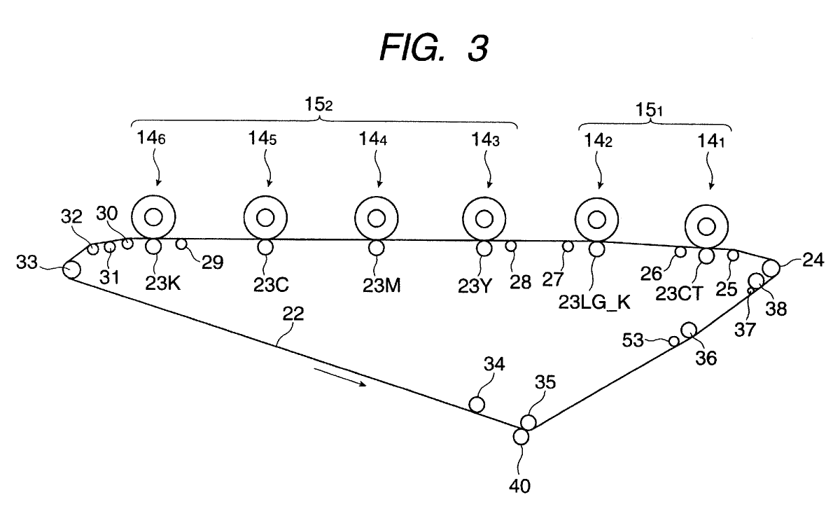

As shown in FIG. 3, the image output unit 5 has six, first to sixth, image forming units (image forming sections) 14₁, 14₂, 14₃, 14₄, 14₅ and 14₆ arranged in accordance with image formation order. The first to sixth image forming units 14₁, 14₂, 14₃, 14₄, 14₅ and 14₆ are divided into a first image forming unit group 15₁ consisting of the two image forming units 14₁ and 14₂ on the upstream side in the image formation order, and a second image forming unit group 15₂ consisting of the four image forming units 14₃, 14₄, 14₅ and 14₆ on the downstream side. Each unit of the first image forming unit group 15₁ located on the upstream side is an ERU (Engineering Replacement Unit) which can be replaced by a service engineer in accordance with user's demand.

In the same manner as in a background-art full color image forming apparatus, the second image forming unit group 15₂ is constituted by image forming units 14Y, 14M, 14C and 14K for forming four color images of yellow (Y), magenta (M), cyan (C) and black (K). In the same manner as in the background art, images are formed with color toners in the yellow (Y), magenta (M) and cyan (C) image forming units 14Y, 14M and 14C, while an image is formed with a high-gloss black toner in the black (K) image forming unit 14K.

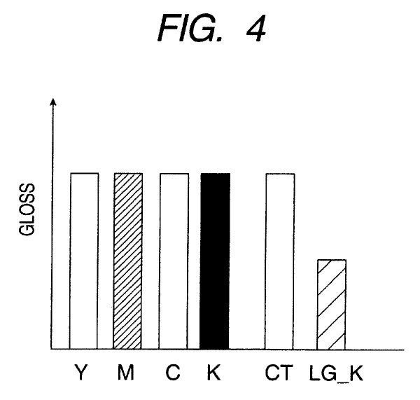

On the other hand, for example, image forming units 14CT and 14LG_K using a transparent toner (CT) and a low-gloss black (LG_K) toner with low glossiness are used as the first image forming unit group 15₁. The transparent toner (CT) is used for improving transfer properties of a toner image when a recording medium having irregularities on the surface, such as embossed paper or rough paper, is used, or for giving gloss to a color image. For example, the transparent toner (CT) is formed to be laminated as a lower portion (lower layer) on an intermediate transferer than color images of yellow (Y), magenta (M), cyan (C), black (K), etc. formed by the second image forming unit group 15₂. On the other hand, unlike the black toner of the black (K) image forming unit 14K of the second group, the low-gloss black (LG_K) toner is used for forming a low-gloss black image when a character image or an image of graphic art or the like is formed. Unlike the black toner of the black (K) image forming unit 14K of the second group, the low-gloss black (LG_K) toner is, for example, made of a low molecular-weight synthetic resin material such as polyester resin. When glossiness of a surface of each toner heated and melted to be fixed on a recording medium is measured by a gloss meter, the low-gloss black (LG_K) toner forms a black image whose glossiness is remarkably lower (for example, about ½) than that of the transparent toner (CT) or any other color toner of yellow (Y), magenta (M), cyan (C) or black (K) as shown in FIG. 4.

In this embodiment, the case where the low-gloss black toner is used as a low-gloss toner with low glossiness will be described by way of example. However, the invention is not limited thereto, but it is a matter of course that any other color toner of yellow (Y), magenta (M), cyan (C) or the like may be used as the low-gloss toner.

As described above, the image data on which the predetermined image processing has been performed in the image processing unit 4 are converted into image data of six colors in accordance with types of units included in the first image forming unit group 15₁ by the same image processing unit 4. When the first image forming unit group 15₁ includes the transparent toner (CT) and low-gloss black (LG₁K) image forming units 14CT and 14LG_K, the image data are converted into image data of transparent toner (CT), low-gloss black (LG_K), yellow (Y), magenta (M), cyan (C) and black (K).

Here, the image processing operation of the image processing unit 4 is controlled by the control unit 100. In the image processing unit 4, image data of transparent toner (CT) is formed, for example, with fixed density in regions where image data of any other color, yellow (Y), magenta (M), cyan (C) or black (K) than low-gloss black (LG_K) are present. Image processing is performed so that image data of transparent toner (CT) are absent from regions corresponding to image data of low-gloss black (LG_K).

Not to say, when any image forming unit is replaced, a toner cartridge for replenishing toner to a developing unit of the image forming unit is also replaced simultaneously in order to prevent the toner from being mixed with any other color toner.

Inside the tandem type digital color printer body 1, for example, the six image forming units 14CT, 14LG_K, 14Y, 14M, 14C and 14K of transparent toner (CT), low-gloss black (LG_K), yellow (Y), magenta (M), cyan (C) and black (K) are disposed in parallel at predetermined horizontal intervals in accordance with user's demand, as shown in FIG. 2.

As shown in FIG. 2, the six image forming units 14CT, 14LG_K, 14Y, 14M, 14C and 14K are fundamentally constituted in the same manner as one another, except the colors to be formed. Roughly speaking, each image forming unit has a photoconductor drum 16, a primary charging scorotron 17, an image exposure unit 18, a developing unit 19 and a cleaner unit 20. The photoconductor drum 16 is an image carrier that is driven to rotate in a predetermined velocity along the arrow A direction. The scorotron 17 charges the surface of the photoconductor drum 16 uniformly. The image exposure unit 18 is an image writing section that performs image exposure upon the surface of the photoconductor drum 16 based on image data corresponding to each color so as to form an electrostatic latent image. The developing unit 19 develops, with toner, the electrostatic latent image formed on the photo conductor drum 16. The cleaning unit 20 according to this embodiment removes residual materials such as toner staying behind on the surface of the photoconductor drum 16.

The image forming units 14CT and 14LG_K are arranged to be replaceable as mentioned above, while their image exposure units 18 are placed not replaceably but fixedly because the image exposure units 18 do not depend on the colors formed by the image forming units 14CT and 14LG_K.

As shown in FIG. 2, image data of corresponding colors are sequentially output from the image processing unit 4 to the image exposure units 18CT, 18LG_K, 18Y, 18M, 18C and 18K of the six image forming units 14CT, 14LG_K, 14Y, 14M, 14C and 14K of transparent toner (CT), low-gloss black (LG_K), yellow (Y), magenta (M), cyan (C) and black (K). The surfaces of the photoconductor drums 16CT, 16LG_K, 16Y, 16M, 16C and 16K are scanned and exposed with laser beams LB emitted from the corresponding image exposure units 18CT, 18LG_K, 18Y, 18M, 18C and 18K in accordance with the corresponding image data respectively, so that electrostatic latent images corresponding to the image data are formed on the surfaces of the photoconductor drums 16CT, 16LG_K, 16Y, 16M, 16C and 16K. The electrostatic latent images formed thus on the surfaces of the photoconductor drums 16CT, 16LG_K, 16Y, 16M, 16C and 16K are developed as toner images of transparent toner (CT), low-gloss black (LG_K), yellow (Y), magenta (M), cyan (C) and black (K) by the developing units 19CT, 19LG_K, 19Y, 19M, 19C and 19K respectively.

As shown in FIG. 2, the toner images of transparent toner (CT), low-gloss black (LG_K), yellow (Y), magenta (M), cyan (C) and black (K) sequentially formed on the photoconductor drums 16CT, 16LG_K, 16Y, 16M, 16C and 16K of the image forming units 14CT, 14LG_K, 14Y, 14M, 14C and 14K are primarily transferred onto an intermediate transfer belt 22 in primary transfer positions N1 by primary transfer rolls 23CT, 23LG_K, 23Y, 23M, 23C and 23K so as to be put on top of one another in accordance with the color of an image to be formed. The primary transfer rolls 23CT, 23LG_K, 23Y, 23M, 23C and 23K serve as primary transfer sections. The intermediate transfer belt 22 is an intermediate transferer shaped like an endless belt, and disposed under the image forming units 14CT, 14LG_K, 14Y, 14M, 14C and 14K. The intermediate transfer belt 22 is hung and looped with a fixed tension among a driving roll 24, a first retract roll 25, a first fixed roll 26, a second retract roll 27, a third retract roll 28, a fourth retract roll 29, a fifth retract roll 30, a second fixed roll 31, a center roll 32, a tension applying roll 33, a prior-to-secondary-transfer roll 34, a back support roll 35, an adjustment roll 36, a first cleaning roll 37 and a second cleaning roll 38. The intermediate transfer belt 22 is driven to circulate with a predetermined moving velocity along the arrow B direction by the driving roll 24 which is driven to rotate by a not-shown dedicated driving motor having an excellent velocity constancy. For example, a flexible synthetic resin film of polyimide, polyamide-imide or the like formed into an endless belt shape is used as the intermediate transfer belt 22.

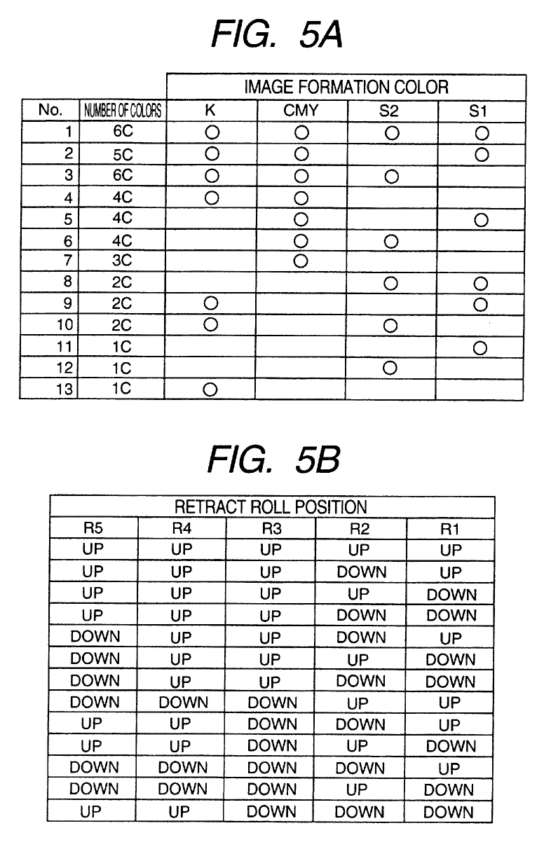

As shown in FIGS. 5A and 5B, the first to fifth retract rolls 25, 27, 28, 29 and 30 are moved by a not-shown moving section in accordance with the color of an image to be formed, so as to contact with or leave the photoconductor drums 16CT, 16LG_K, 16Y, 16M, 16C and 16K together with the primary transfer rolls 23CT, 23LG_K, 23Y, 23M, 23C and 23K respectively. In FIG. 5A, the reference sign S1 represents a first image forming section of the first image forming unit group, and S2 represents a second image forming section of the first image forming unit group. In FIG. 5B, the reference signs R1 to R5 represent the first to fifth retract rolls respectively, and UP and DOWN designate the state where the retract roll contacts with a corresponding photoconductor drum and the state where the retract roll leaves the corresponding photoconductor drum, respectively.

The toner images of transparent toner (CT), low-gloss black (LG_K), yellow (Y), magenta (M), cyan (C) and black (K) transferred in multiple layers onto the intermediate transfer belt 22 are secondarily transferred onto a recording sheet of paper 41 due to an electrostatic force in a secondary transfer position N2 by a transfer bias applied between the back support roll 35 and a secondary transfer roll 40. The secondary transfer roll 40 is a secondary transfer section. The recording sheet of paper 41 is a recording medium. The recording sheet of paper 41 on which the toner images in accordance with the color of an image to be formed have been transferred is conveyed to the fixing unit 44 by two conveyor belts 42 and 43.

The recording sheet of paper 41 on which the toner images of the respective colors have been transferred is subjected to a fixing process with heat and pressure by the fixing unit 44. The recording sheet of paper 41 is discharged onto a discharge tray 45 provided outside the printer body 1.

As shown in FIG. 2, recording sheets of paper 41 with a desired size and material are separated and fed one by one from a paper feed tray 46 by a paper feed roll 47 and a pair of paper separation rolls 48 and 49, and once conveyed to registration rolls 52 through a paper conveyance path 51 where conveyance rolls 50 are disposed. The paper feed tray 46 is disposed in a bottom portion of the printer body 1. Each recording sheet of paper 41 fed from the paper feed tray 46 is sent out to the secondary transfer position N2 by the registration rolls 52 in synchronization with the toner images on the intermediate transfer belt 22. The registration rolls 52 are driven to rotate at predetermined timing. Although only one paper feed tray 46 is illustrated, a plurality of paper feed trays having sheets of recording paper 41 with different sizes or the same size may be provided. A large number of recording sheets of paper 41 can be fed from each paper feed tray 46. It is a matter of course that normal paper can be fed as the recording paper 41. In addition to the normal paper, other recording media having irregularities on their surfaces, such as embossed paper and rough paper, can be fed as the recording paper 41.

After the transfer process of the toner images is terminated, residual toners etc. are removed from the photoconductor drums 16CT, 16LG_K, 16Y, 16M, 16C and 16K by cleaning units 20CT, 20LG_K, 20Y, 20M, 20C and 20K. Then, the photoconductor drums 16CT, 16LG_K, 16Y, 16M, 16C and 16K are ready for the next image forming process. On the other hand, residual toners, paper dust, etc. are removed from the intermediate transfer belt 22 by the first cleaning roll 37, the second cleaning roll 38 and not-shown cleaning brushes or cleaning blades opposed to the first and second cleaning rolls 37 and 38 through the intermediate transfer belt 22.

In FIG. 2, the reference numeral 53 represents a cleaning brush for cleaning the inner surface of the intermediate transfer belt 22.

In the digital color printer having the aforementioned configuration, as shown in FIG. 3, the first image forming unit group 15₁ can be replaced in accordance with user's demand as described above. As shown in FIG. 2, for example, the transparent toner (CT) image forming unit 14CT and the low-gloss black (LG_K) image forming unit 14LG_K are used as the first image forming unit group 15₁.

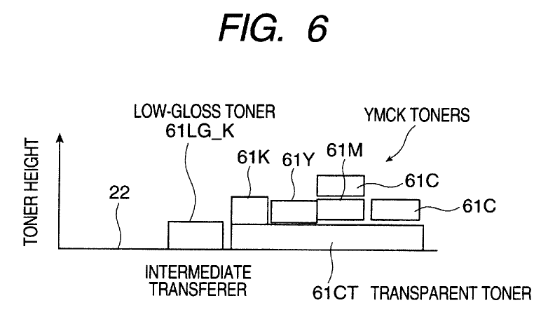

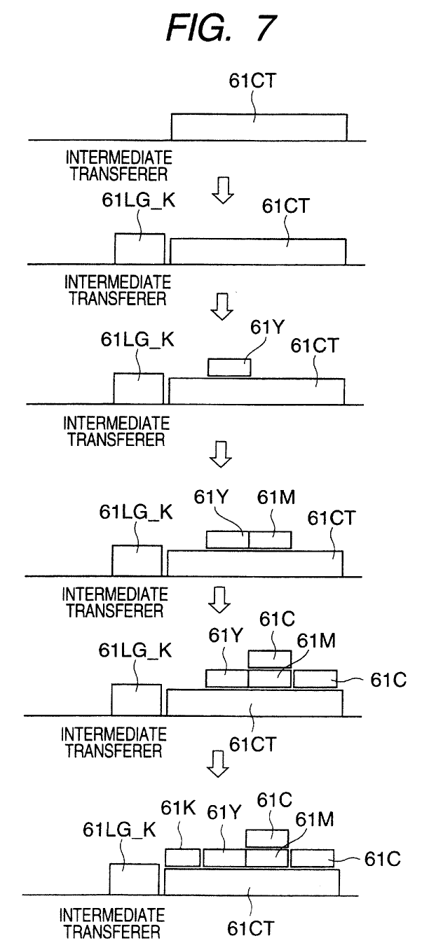

The transparent toner (CT) image forming unit 14CT forms a toner image 61CT out of the transparent toner (CT) uniformly with predetermined density all over the image region except an image region for a toner image 61LG_K of low-gloss black (LG_K), for example, as shown in FIG. 6. By the yellow (Y), magenta (M), cyan (C) and black (K) image forming units 14Y, 14M, 14C and 14K, toner images 61Y, 61M, 61C and 61K of full color or the like are formed on the intermediate transfer belt 22 on which the toner image 61CT of the transparent toner (CT) has been uniformly formed by the transparent toner (CT) image forming unit 14CT. After that, as shown in FIG. 7, all the color toner images including the transparent toner (CT) and the yellow (Y), magenta (M), cyan (C) and black (K) toner images 61Y, 61M, 61C and 61K primarily transferred into multiple layers onto the intermediate transfer belt 22, excluding the low-gloss black (LG_K) toner image 61LG_K, are secondarily transferred onto the recording sheet of paper 41 in the secondary transfer position N2 surely and excellently so that the toner image of the transparent toner (CT) is placed as the uppermost layer. Thus, when the plurality of toner images secondarily transferred onto the recording sheet of paper 41 are heated and melted to be thereby fixed to the recording sheet of paper 41 by the fixing unit 45, all the color toner images including the transparent toner (CT) located in the uppermost layer are melted and fixed. Thus, a glossy full color image can be obtained.

On this occasion, the low-gloss black (LG_K) image forming unit 14LG_K located on the downstream side of the transparent toner (CT) image forming unit 14CT serves to form an image of low-gloss black (LG_K). Therefore, the image of the transparent toner (CT) is not formed in the position for the image of low-gloss black (LG_K).

According to the digital color printer having the aforementioned configuration according to this embodiment, it is possible to prevent gloss from occurring in an image of a low-gloss toner with low glossiness due to a transparent toner transferred under the low-gloss toner on an intermediate transferee when an image is formed using the low-gloss toner and the transparent toner in the intermediate transfer type image forming units. Description about this point will be given next.

That is, as shown in FIG. 2, the digital color printer has the six image forming units 14CT, 14LG_K, 14Y, 14M, 14C and 14K of transparent toner (CT), low-gloss black (LG_K), yellow (Y), magenta (M), cyan (C) and black (K).

In the digital color printer, for example, the transparent toner (CT) image forming unit 14CT is mounted on the most upstream position of the first image forming unit group 15₁, and the low-gloss black (LG_K) image forming unit 14LG_K is mounted on the downstream side of the transparent toner (CT) image forming unit 14CT. In the image processing unit 4, the control unit 100 detects that the transparent toner (CT) and low-gloss black (LG_K) image forming units 14CT and 14LG_K have been mounted in the first image forming unit group 15₁. Under control of the same control unit 100, image data are converted into not only yellow (Y) image data, magenta (M) image data, cyan (C) image data and black (K) image data but also low-gloss black (LG_K) image data and transparent toner (CT) image data. The transparent toner (CT) image data are set with fixed density all over the same regions as the respective yellow (Y), magenta (M), cyan (C) and black (K) image data excluding the low-gloss black (LG_K) image data.

In the digital color printer, based on color-separated image signals supplied from the image processing unit 4, image data of corresponding colors are sequentially output to the image exposure units 18CT, 18LG_K, 18Y, 18M, 18C and 18K of the six image forming units 14CT, 14LG_K, 14Y, 14M, 14C and 14K of transparent toner (CT), low-gloss black (LG_K), yellow (Y), magenta (M), cyan (C) and black (K). The surfaces of the photoconductor drums 16CT, 16LG_K, 16Y, 16M, 16C and 16K are scanned and exposed with laser beams LB emitted from the corresponding image exposure units 18CT, 18LG_K, 18Y, 18M, 18C and 18K in accordance with the corresponding image data respectively, so that electrostatic latent images are formed on the surfaces of the photoconductor drums 16CT, 16LG_K, 16Y, 16M, 16C and 16K. The electrostatic latent images formed thus on the surfaces of the photoconductor drums 16CT, 16LG_K, 16Y, 16M, 16C and 16K are developed as toner images of transparent toner (CT), low-gloss black (LG_K), yellow (Y), magenta (M), cyan (C) and black (K) by the developing units 19CT, 19LG_K, 19Y, 19M, 19C and 19K respectively.

On that occasion, in the transparent toner (CT) image forming unit 14CT, image exposure by the image exposure unit 18CT is controlled by the control unit 100 based on the transparent toner (CT) image data output from the image processing unit 4, so as not to form the transparent toner (CT) image in the low-gloss black (LG_K) image region, as shown in FIG. 7.

In the five low-gloss black (LG_K), yellow (Y), magenta (M), cyan (C) and black (K) image forming units 14LG_K, 14Y, 14M, 14C and 14K excluding the transparent toner (CT) image forming unit 14CT, images are formed based on the low-gloss black (LG_K), yellow (Y), magenta (M), cyan (C) and black (K) image data respectively.

The low-gloss black (LG_K) image forming unit 14LG_K forms a black image which has the same color as the black (K) image forming unit 14K but which is a low-gloss black image with low glossiness unlike the black (K) image forming unit 14K. Normally, therefore, the black (K) image is not formed above the low-gloss black image. In this embodiment, however, even if the black (K) image is present above the low-gloss black image on the intermediate transfer belt 22, the low-gloss black image is located above the black (K) image after being transferred onto a recording medium. Therefore, the black (K) image may be formed above the low-gloss black image.

The toner images of the respective colors formed by the six transparent toner (CT), low-gloss black (LG_K), yellow (Y), magenta (M), cyan (C) and black (K) image forming units 14CT, 14LG_K, 14Y, 14M, 14C and 14K as described above are sequentially primarily transferred onto the intermediate transfer belt 22 as shown in FIG. 7. After that, the transparent toner (CT), low-gloss black (LG_K), yellow (Y), magenta (M), cyan (C) and black (K) toner images primarily transferred onto the intermediate transfer belt 22 are collectively secondarily transferred onto the recording sheet of paper 41 in the secondary transfer position N2, and fixed by the fixing unit 44. Thus, a full color image or the like is formed.

On this occasion, on the intermediate transfer belt 22, the toner image of the transparent toner (CT) which has been first transferred onto the intermediate transfer belt 22 is located in the lowermost portion, and the toner images of yellow (Y), magenta (M), cyan (C) and black (K) are located on the toner image of the transparent toner (CT), as shown in FIG. 7.

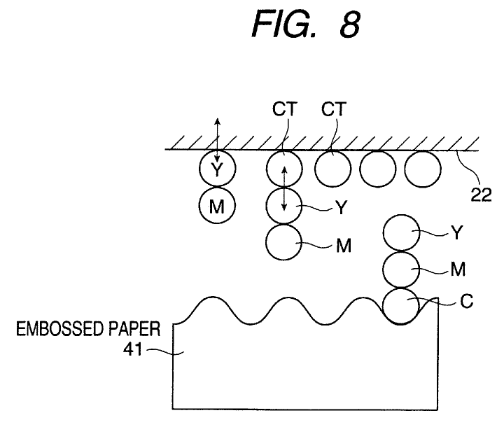

Thus, when a sheet of embossed paper, rough paper or the like with irregularities on its surface is used as the recording sheet of paper 41 so that an electrostatic transfer force is relatively weak in a groove portion of the embossed paper or the like in the secondary transfer of the transparent toner (CT), low-gloss black (LG_K), yellow (Y), magenta (M), cyan (C) and black (K) toner images from the intermediate transfer belt 22 onto the recording sheet of paper 41, the image of the transparent toner (CT) is present on the surface of the intermediate transfer belt 22 having a higher adhesive force than the adhesive force between toner particles so that a part of the toner image of the transparent toner (CT) may stay behind on the surface of the intermediate transfer belt 22 as shown in FIG. 8. Even in that case, the other toner images of yellow (Y), magenta (M), cyan (C) and black (K) can be secondarily transferred onto the recording sheet of paper 41 surely.

On the other hand, the transparent toner (CT) is absent under the low-gloss black (LG_K) toner image. However, there is no fear that the low-gloss black (LG_K) toner image and another toner image are put on top of each other. Thus, the low-gloss black (LG_K) toner image can be secondarily transferred excellently. In addition, due to the absence of the transparent toner (CT), there is no fear that gloss is given unwillingly, but a character image or an image of graphic art or the like can be formed with the low-gloss black (LG_K) toner excellently. Thus, the image quality can be improved.

### Second Exemplary Embodiment

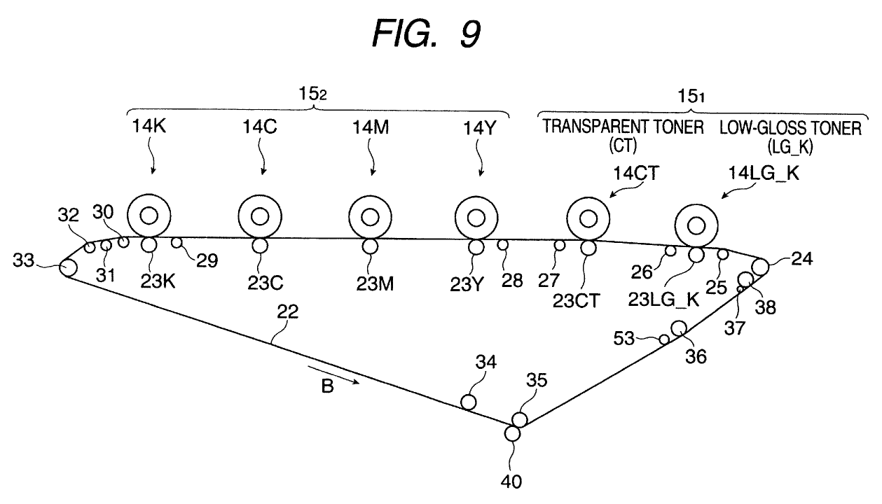

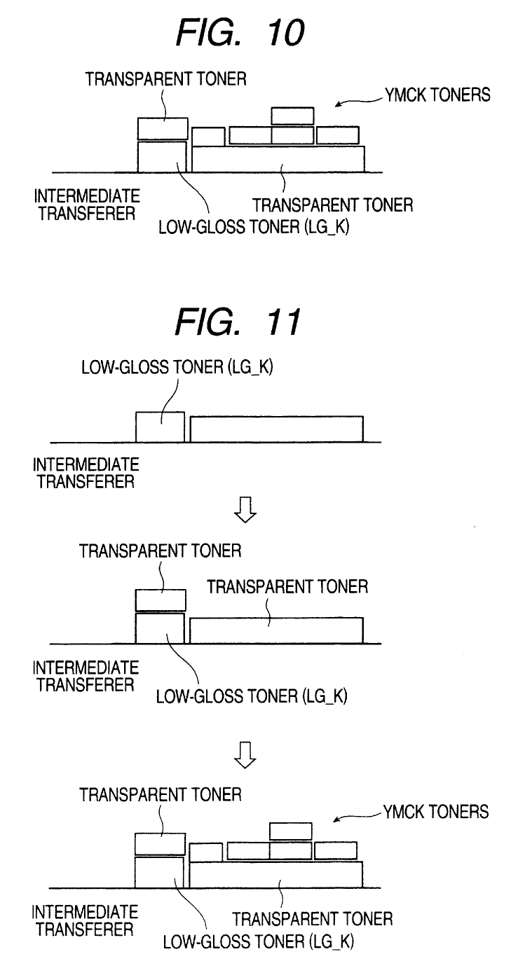

FIG. 9 shows a second exemplary embodiment of the invention. Description will be made with reference to FIG. 9, in which parts the same as those in the previous embodiment are referred to by the same numerals. In the second exemplary embodiment, a plurality of image forming sections and an intermediate transferee are provided. Of the image forming sections, an image forming section that forms an image of a low-gloss toner with lower glossiness than that of any other color toner is disposed more upstream in image formation order than an image forming section that forms an image of a transparent toner. A plurality of toner images formed by the image forming sections is transferred onto the intermediate transferee so that the image of the transparent toner is not transferred under the image of the low-gloss toner.

That is, according to the second exemplary embodiment, as shown in FIG. 9, a low-gloss black (LG_K) image forming unit 14LG_K and a transparent toner (CT) image forming unit 14CT are provided as a first image forming unit group 15₁. The low-gloss black (LG_K) image forming unit 14LG_K is disposed on the most upstream side in image formation order, and the transparent toner (CT) image forming unit 14CT is disposed on the downstream side of the low-gloss black (LG_K) image forming unit 14LG_K. In addition, four image forming units 14Y, 14M, 14C and 14K of yellow (Y), magenta (M), cyan (C) and black (K) are disposed in this order as a second image forming unit group 15₂ in the same manner as in the first exemplary embodiment.

In addition, the second exemplary embodiment is different from the first exemplary embodiment in that an image of transparent toner (CT) is formed all over the image region including the image region of the low-gloss black (LG_K) image forming unit 14LG_K in the transparent toner (CT) image forming unit 14CT.

On that occasion, in the second exemplary embodiment, as shown in FIG. 9, the low-gloss black (LG_K) image forming unit 14LG_K is disposed on the most upstream side in the image formation order. Accordingly, even if the transparent toner (CT) image is formed all over the image region including the image region of the low-gloss black (LG_K) image forming unit 14LG_K in the transparent toner (CT) image forming unit 14CT, there is no fear that the transparent toner (CT) image is formed under the low-gloss black (LG_K) image on the intermediate transfer belt 22, as shown in FIG. 11.

In the second exemplary embodiment, as long as the low-gloss black (LG_K) image forming unit 14LG_K is disposed on the most upstream side in the image formation order, no special control operation is required. Thus, the configuration can be simplified.

On the contrary, the transparent toner (CT) image is present under the low-gloss black (LG_K) image on the recording sheet of paper 41. Accordingly, there is no fear that gloss is given unwillingly by the transparent toner (CT) image, but a character image or an image of graphic art or the like of the low-gloss black (LG_K) toner can be formed excellently. Thus, the image quality can be improved.

The other configuration and operation are similar to those in the first exemplary embodiment, and description thereof will be omitted.

A so-called tandem type image forming apparatus provided with a plurality of image forming sections has been described in the first exemplary embodiment. However, the invention can be also applied to a so-called multi-cycle image forming apparatus. The image forming apparatus has only one image carrier, while electrostatic latent images formed on the image carrier are developed with respective color toners of transparent toner (CT), low-gloss black (LG_K), yellow (Y), magenta (M), cyan (C) and black (K) sequentially. The toner images of the respective colors are sequentially transferred onto an intermediate transferee.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. An image forming apparatus comprising:
an image forming section that forms a plurality of images comprising an image of a low-gloss toner lower in glossiness than any other color toner for forming color image and an image of a transparent toner;
an intermediate transferee to which the plurality of images formed by the image forming section are transferred; and
a control section that controls a position for forming the image of the transparent toner, so as to prevent the image of the transparent toner from being transferred under the image of the low-gloss toner on the intermediate transferer.

2. The image forming apparatus according to claim 1, wherein:
the image forming section that forms the image of the transparent toner is disposed in a most upstream position in image formation order; and
the control section makes control so as not to form the image of the transparent toner in an image region of the image of the low-gloss toner.

3. An image forming apparatus comprising:
a plurality of image forming sections comprising an image forming section that forms an image of a low-gloss toner lower in glossiness than any other color toner for forming color image and that is disposed on a more upstream side in image formation order than an image forming section that forms an image of a transparent toner; and
an intermediate transferee to which a plurality of toner images formed by the plurality of image forming sections are transferred so that the image of the transparent toner is not transferred under the image of the low-gloss toner on the intermediate transferer.

4. The image forming apparatus according to claim 1, wherein the low-gloss toner is a black low-gloss toner.

5. The image forming apparatus according to claim 3, wherein the low-gloss toner is a black low-gloss toner.

6. The image forming apparatus according to claim 1, which further comprises an image forming section that forms an image of a toner which has the same color as the low-gloss toner lower in glossiness than any other color toner, and which has different glossiness from the glossiness of the low-gloss toner.

7. The image forming apparatus according to claim 3, wherein the plurality of image forming sections comprise an image forming section that forms an image of a toner which has the same color as the low-gloss toner lower in glossiness than any other color toner, and which has different glossiness from the glossiness of the low-gloss toner.

8. The image forming apparatus according to claim 6, wherein the toner which has the same color as the low-gloss toner lower in glossiness than any other color toner, and which has different glossiness from the glossiness of the low-gloss toner, is a black high-gloss toner with high glossiness.

9. The image forming apparatus according to claim 7, wherein the toner which has the same color as the low-gloss toner lower in glossiness than any other color toner, and which has different glossiness from the glossiness of the low-gloss toner, is a black high-gloss toner with high glossiness.
